(19) United States
(12) Patent Application Publication
(10) Pub. No.: US 2006/0278502 A1
(43) Pub. Date: Dec. 14, 2006

(54) Rubber-contact member and key input apparatus comprising the same

(75) Inventor: Dong-Su Nam, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/444,377

(22) Filed: Jun. 1, 2006

(30) Foreign Application Priority Data
Jun. 9, 2005 (KR) 2005-49201

(51) Int. Cl. H01H 13/72

(52) U.S. Cl. 200/5 A

(57) ABSTRACT

A rubber-contact member and a key input apparatus including the same are provided. The rubber-contact member has a plurality of key contacts corresponding to a plurality of circuit contacts located on the upper surface of a printed circuit board (PCB) and includes foldable parts for partitioning the entire area of the rubber-contact member into two or more zones, making an interval between the zones easily adjusted while the foldable parts deform, and therefore making the zones match in a one-to-one correspondence relevant zones of the PCB.

### CROSS-REFERENCE TO RELATED APPLICATIONS

This application claims the benefit under 35 U.S.C. §119(a) of Korean Patent Application No. 10-2005-0049201, filed on Jun. 9, 2005, in the Korean Intellectual Property Office, the entire disclosure of which is hereby incorporated by reference.

### BACKGROUND OF THE INVENTION

1. Field of the Invention

The present invention relates to a key input apparatus of an electronic device. More particularly, the present invention relates to a key input apparatus of an electronic device having a rubber-contact member included in the key input apparatus.

2. Description of the Related Art

In general, key input apparatuses are used to input a control signal desired by a user. Such key apparatuses are included in the main bodies of electronic devices, such as printers, copy machines, and facsimiles, or control devices of electronic devices, such as remote controls of TVs and VCRs. There exist various kinds of key input apparatuses, most of which include carbon contacts on a printed circuit board (PCB). Such configuration allows a user to input a signal by pushing a key to thereby contacts a contact portion below the lower surface of the key to a carbon contact. An elastic substance such as rubber or silicon, which can easily deform and restore to its initial shape, is used to relocate a pushed key to an original location. A rubber-contact member has a structure including a plurality of keys placed on a plate made of an elastic substance such as rubber or silicon.

The plurality of keys of the rubber-contact member are at locations corresponding to carbon contacts. In other words, circuit contacts, of a PCB, respectively protrude towards the upper portion of the circuit contacts in a dome or conical shape, and have key contacts, which are also carbon contacts, below the lower surfaces of the keys. Each skirt part forming an incline of the dome or conical shape has a thinner thickness compared to other parts that contact the PCB in order to be efficient for repeated deformations and restorations.

Most electronic devices include key input apparatuses having keys which are classified into groups according to their functions. For example, a numeric key group for inputting numbers, a memory key group for shortcut dial, and a function key group for scanning, printing, and the like are usually arranged on the surface of a facsimile. In this case, to reduce the manufacturing cost of devices, in other words the parts' manufacturing cost and assembly cost, it is preferable that the rubber-contact member be formed in one body over a wide area in which various key groups are arranged. However, an increase of the size of the rubber-contact member may cause problems as described below.

FIG. 1 is a plan view of a conventional key input apparatus, and FIG. 2 is a cross-sectional view taken along line II-II of FIG. 1. A plurality of key holes 11 are formed in a cover 10 of an electronic device's operational panel 100 to expose a plurality of keys 21. The plurality of keys 21 are grouped and arranged according to their functions. A PCB 30 having a plurality of circuit contacts 31 is located under the cover 10, and a rubber-contact member 20 having a plurality of key contacts 25 in a one-to-one correspondence with the circuit contacts 31 is located on the upper surface of the PCB 30.

The key structure of the rubber-contact member 20 having the key contacts 25 protrudes to the upper direction of the circuit contacts 31 in a dome or conical shape, and the key contacts 25 are placed on the lower surface of the keys 21. Each skirt part 26 forming an incline of the dome or conical shape has a thinner thickness compared to other parts of the rubber-contact member 20 in order to be efficient for repeated deformations and restorations.

The rubber-contact member 20 for various key groups can be formed in one body over a wide area. However, in this case, the rubber-contact member 20 has a large manufacturing tolerance due to a material characteristic and expands due to heat generated by an electronic device.

The key contacts 25 of the rubber-contact member 20 must be arranged to match the corresponding circuit contacts 31. If the size of the rubber-contact member 20 is changed due to the manufacturing tolerance thereof or due to heat expansion, an arrangement and/or alignment error between each key contact 25 and the corresponding circuit contact 31 gradually increases with regard to the distance from the left end of FIG. 1 or FIG. 2, which is the basis of arrangement. Thus, for the right key group of FIG. 1 or FIG. 2, the key structure in which the keys 21 are formed in one body is biased to the right, and thus the circuit contacts 31 of the PCB 30 and the center of the key holes 11 of the cover 10 are mismatched.

The arrangement error can cause an interference between each key 21 and the corresponding key hole 11 and a faulty operation since each key contact 25 and the corresponding circuit contacts 31 cannot be smoothly contacted.

Accordingly, there is a need for an improved contact member which reduces alignment and arrangement errors, and an apparatus comprising the same.

### SUMMARY OF THE INVENTION

Exemplary embodiments of the present invention address at least the above problems and/or disadvantages and provide at least the advantages described below. Accordingly, an aspect of the present invention is to provide a rubber-contact member formed in one body for a plurality of key groups such that its size can be easily adjusted to reduce an arrangement and/or alignment error with respect to a printed circuit board (PCB).

The exemplary embodiments of the present invention also provide a key input apparatus for use in an electronic device, the apparatus including a rubber-contact member by which proper alignment and arrangement between key holes in a cover and circuit contacts of a PCB is achieved.

According to an exemplary aspect of the present invention, there is provided a rubber-contact member having a plurality of key contacts corresponding to a plurality of circuit contacts located on the upper surface of a printed circuit board (PCB), the rubber contact member comprising foldable parts for partitioning an entire area into two or more zones, making an interval between the zones to be easily adjusted while the foldable parts deform, and therefore allowing the zones to be in a one-to-one correspondence with relevant zones of the PCB.

The exemplary rubber-contact member may be formed long in a horizontal direction to correspond to the plurality of key groups, the foldable parts may be formed across the rubber-contact member in a vertical direction, and therefore, the zones may be arranged in the horizontal direction. This is because the manufacturing tolerance and thermal expansion have a higher effect in the longitudinal direction of the rubber-contact member. The horizontal direction and the vertical direction are relatively perpendicular to each other.

The exemplary foldable parts may be formed to have a thinner thickness compared to other parts, and may be formed in various shapes, for example, they may be formed to have at least one convex area.

Each of the zones partitioned by the exemplary foldable parts may comprise a location limitation part to make the rubber-contact member maintain contact with the relevant zones of the PCB. The exemplary location limitation parts may be formed in various shapes, for instance, a hole shape or a dome shape to be easily combined with ribs of the PCB or a cover.

According to another exemplary aspect of the present invention, there is provided a key input apparatus comprising a printed circuit board (PCB) having a plurality of circuit contacts on the upper surface thereof, a rubber-contact member having a plurality of key contacts corresponding to the plurality of circuit contacts and a cover on which a plurality of key holes are formed to expose keys located above the key contacts.

The keys may be formed in one body with the rubber-contact member. When a keypad may be placed on the key contacts, the keys may be buttons installed on the keypad.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a plan view of a prior art input apparatus;

FIG. 2 is a cross-sectional view taken along line II-II of FIG. 1;

FIG. 3 is a plan view of a rubber-contact member according to an exemplary embodiment of the present invention;

FIG. 4 is a sectional view of a key input apparatus according to an exemplary embodiment of the present invention using the rubber-contact member of FIG. 3;

FIG. 5 is a sectional view of another exemplary embodiment of a key input apparatus;

FIG. 6 is a plan view of a rubber-contact member according to yet another exemplary embodiment of the present invention;

FIG. 7 is a sectional view of a key input apparatus according to an exemplary embodiment of the present invention using the rubber-contact member of FIG. 6;

FIG. 8 is a detailed sectional view of a foldable part of a rubber-contact member according to an exemplary embodiment of the present invention; and

FIG. 9 is a detailed sectional view of an exemplary modification of the foldable part of FIG. 8.

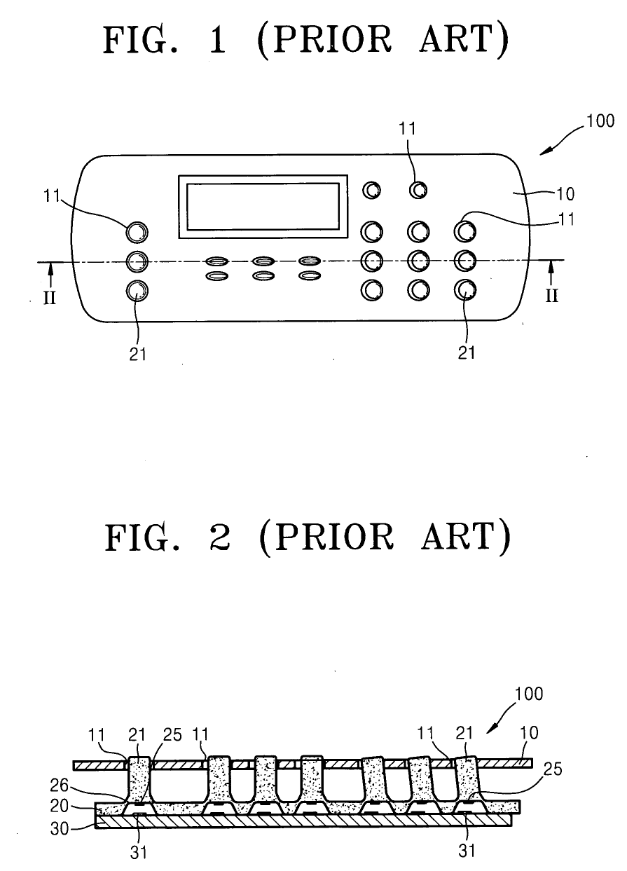

Throughout the drawings, the same drawing reference numerals will be understood to refer to the same elements, features, and structures.

### DETAILED DESCRIPTION OF EXEMPLARY EMBODIMENTS

Exemplary embodiments of the present invention will now be described more fully with reference to the accompanying drawings.

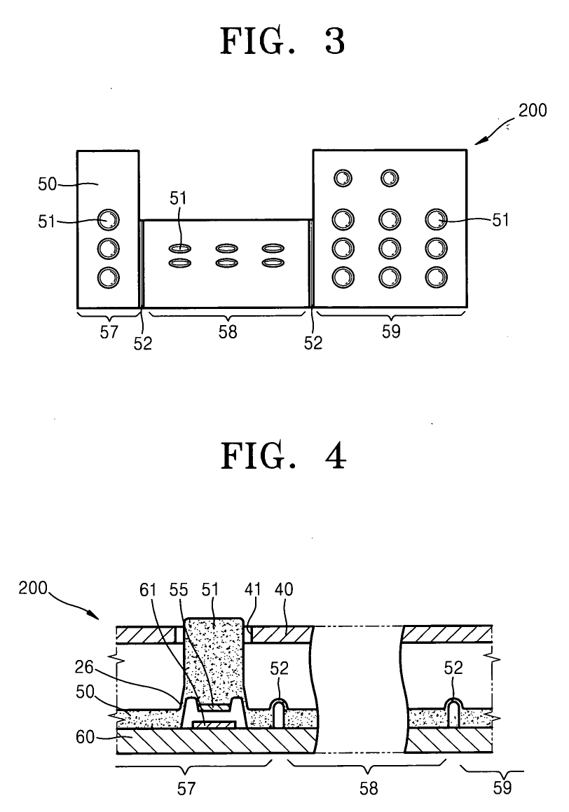

FIG. 3 is a plan view of a rubber-contact member 50 according to an exemplary embodiment 200 of the present invention. Referring to FIG. 3, in the present exemplary embodiment 200, the rubber-contact member 50 is formed long in a certain direction (e.g., a horizontal direction) and includes two foldable parts 52 partitioning the area into three zones 57, 58, and 59. In each of the three zones 57, 58, and 59, a plurality of keys 51 of a group are formed, and key contacts (not shown), which are carbon contacts, are located on the lower surfaces of the keys 51.

The rubber-contact member 50 is later disposed on a PCB so that the key contacts are arranged above circuit contacts (not shown) of the PCB. In the rubber-contact member 50, each of the two foldable parts 52 can be made narrower or wider such that locations of the zones 57, 58, and 59 can be adjusted to match relevant zones of the PCB.

FIG. 4 is a sectional view of a key input apparatus according to an exemplary embodiment of the present invention using the rubber-contact member 50 of FIG. 3. Referring to FIG. 4, the key input apparatus according to the first exemplary embodiment 200 includes a cover 40, the rubber-contact member 50, and a PCB 60. A plurality of holes 41 are formed in the cover 40 to expose the plurality of keys 51 protruding from the rubber-contact member 50. The plurality of keys 51 can be grouped according to their functions.

The PCB 60 having a plurality of circuit contacts 61 is located below the cover 40 of the key input apparatus, and the rubber-contact member 50 having a plurality of key contacts 55 is located on the PCB 60. The plurality of key contacts 55 are in a one-to-one correspondence with the plurality of circuit contacts 61.

The key structure of the rubber-contact member 50 may be any structure which can be applied to conventional rubber-contact members. For example, the rubber-contact member 50 can protrude in the area of the circuit contacts 61 in a dome or conical shape, and the plurality of key contacts 55 can be located on the lower surfaces of the protrusions. In one exemplary embodiment, each skirt part 26 forming an incline of the dome or conical shape has a thinner thickness compared to other parts of the rubber-contact member 50 so as to be efficient for repeated deformations and restorations. Each key 51 can be formed above each key contact 55 in one body with the rubber-contact member 50 and exposed through each key hole 41 of the cover 40.

The rubber-contact member 50 comprises foldable parts 52 for partitioning the area into two or more zones. According to the first exemplary embodiment 200, the two foldable parts 52 divide the rubber-contact member 50 into three zones 57, 58, and 59. Each of the foldable parts 52 has a relatively thin thickness and comprises at least one convex area. The foldable parts 52 are relatively easily deformed, and therefore, the width of each foldable part 52 can be widened or narrowed to adjust locations of the zones 57, 58, and 59.

Thus, even if the rubber-contact member 50 formed in one body over a wide area has a large manufacturing tolerance, the zones 57, 58, and 59 in which the plurality of keys 51 are provided can be arranged to match the relevant zones of the PCB 60 by adjusting the locations of the zones 57, 58, and 59.

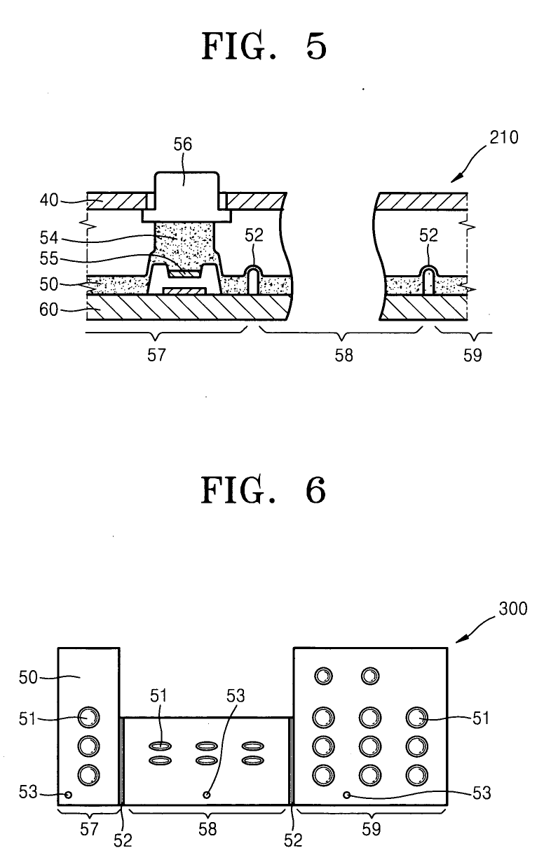

FIG. 5 is a sectional view of another exemplary embodiment 210 of a key input apparatus. The key structure according to the exemplary modified example 210 uses another conventional key structure and has a pattern in which each button 56 is capped on each keypad 54 formed above each key contact 55 of the rubber-contact member 50

FIG. 6 is a plan view of a rubber-contact member 50 according to another exemplary embodiment 300 of the present invention. The rubber-contact member 50 according to the exemplary embodiment 300 is similar to that of the first exemplary embodiment 200 in that it is partitioned into three zones 57, 58, and 59 by two foldable parts 52 formed in the vertical direction. However, the rubber-contact member 50 according to the second exemplary embodiment 300 has at least one location limitation part 53 in each of the zones 57, 58, and 59. The location limitation parts 53 have a structure for making the zones 57, 58, and 59 match the corresponding zones of the PCB 60, and therefore the locations of the zones 57, 58, and 59 can be easily determined when the rubber-contact member 50 is assembled. In addition, even if the size of the rubber-contact member 50 changes due to thermal expansion and other factors after being assembled in a key input apparatus, the location limitation parts 53 can maintain a state in which the zones 57, 58, and 59 are arranged to match the corresponding zones of the PCB 60. In this case, intervals between the zones 57, 58, and 59, in other words the widths of the foldable parts 52, are only changed.

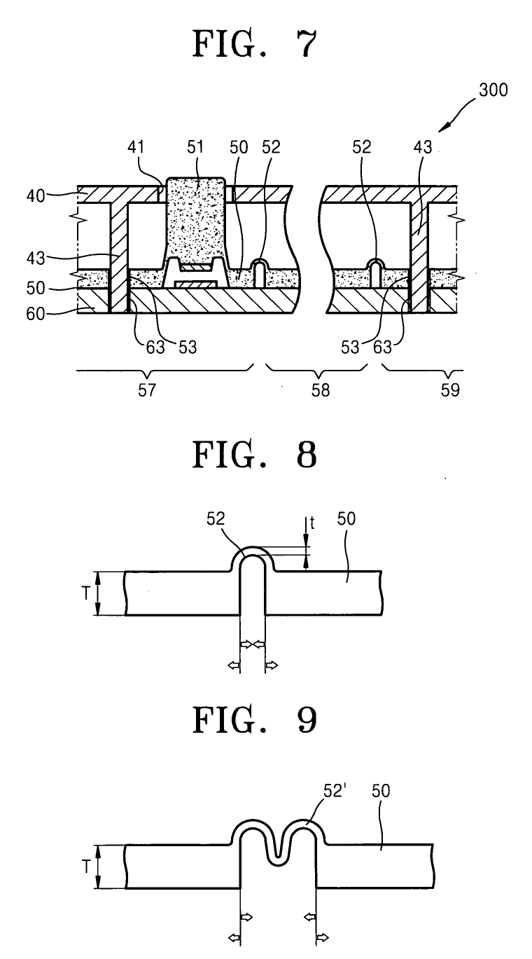

FIG. 7 is a sectional view of a key input apparatus using the rubber-contact member of FIG. 6. Referring to FIG. 7, according to the second exemplary embodiment 300, the rubber-contact member 50 has at least one location limitation part 53 in each of the zones 57, 58, and 59. Holes are formed in the location limitation part 53, and the holes match location limitation holes 63 formed in the PCB 60 in a state in which key contacts located below the rubber-contact member 50 are placed above relevant circuit contacts of the PCB 60. Location limitation ribs 43 protruding from the lower surface of the cover 40 are inserted into the holes formed in the location limitation parts 53 and the location limitation holes 63 of the PCB 60.

Due to the combination of the location limitation ribs 43, the holes formed in the location limitation parts 53, and the location limitation holes 63, the rubber-contact member 50, the PCB 60, and the cover 40 can be easily arranged, and even if the size of the rubber-contact member 50 changes, the alignment and arrangement state can be maintained since only the foldable parts 52 are slightly changed.

FIG. 8 is a detailed sectional view of the foldable part 52 of the rubber-contact member 50 according to an exemplary embodiment of the present invention. Referring to FIG. 8, the foldable part 52 should only partition the rubber-contact member 50 into a plurality of zones and adjust an interval between the partitioned zones within a deformed range of the foldable part 52. The foldable part 52 can have various shapes, for instance, a convex shape. However, it is preferable that the thickness t of the foldable part 52 be thinner than the thickness T of other part of the rubber-contact member 50 so that the foldable part 52 can be easily deformed.

Locations of zones of the rubber-contact member 50 adjacent to the foldable part 52 can be adjusted in the arrow directions.

FIG. 9 is a detailed sectional view of an exemplary modification of the foldable part 52. Referring to FIG. 9, a foldable part 52′ can be formed to have at least two convex areas. The larger the number of continuously formed convex areas, the wider the adjustable range of the foldable part 52′.

As described above, according to exemplary embodiments of the present invention, a rubber-contact member is partitioned into a plurality of zones by foldable parts, and intervals between the zones can be easily adjusted within a deformable range of the foldable parts. Thus, each zone of the rubber-contact member can be arranged to match each corresponding zone of a PCB, thereby reducing an arrangement and/or alignment error between them. That is, by using a single body type rubber-contact member corresponding to a plurality of key groups, the quality of a key input apparatus is increased by guaranteeing correctness of an arrangement between a PCB and a rubber-contact member.

In addition, in the key input apparatus according to exemplary embodiments of the present invention, key holes in a cover, keys of the rubber-contact member, and circuit contacts of the PCB have a good arrangement and alignment over a wide area, and the arrangement of the rubber-contact member can be maintained even after being assembled in the key input apparatus regardless of thermal expansion and other factors.

While the present invention has been particularly shown and described with reference to exemplary embodiments thereof, it will be understood by those of ordinary skill in the art that various changes in form and details may be made therein without departing from the spirit and scope of the present invention as defined by the following claims and the full scope of equivalents thereof.

What is claimed is:

1. A rubber-contact member having a plurality of key contacts corresponding to a plurality of circuit contacts located on the upper surface of a printed circuit board (PCB), the rubber-contact member comprising:
foldable parts for partitioning the rubber-contact member into two or more zones, making an interval between the zones easily adjusted as the foldable parts deform and allowing the zones to be in a one-to-one correspondence with relevant zones of the PCB.

2. The rubber-contact member of claim 1, wherein the rubber-contact member has a horizontal direction, the foldable parts are formed in a vertical direction, and the zones are arranged in the horizontal direction.

3. The rubber-contact member of claim 1, wherein a thickness of each foldable part is less than a thickness of adjacent parts thereto.

4. The rubber-contact member of claim 1, wherein each foldable part comprises at least one convex area having a thickness less than a thickness of adjacent parts thereto.

5. The rubber-contact member of claim 1, further comprising location limitation parts, at least one of the location limitation parts being located in each zone.

6. A key input apparatus comprising:
a printed circuit board (PCB) comprising a plurality of circuit contacts on an upper surface thereof,
a rubber-contact member comprising a plurality of key contacts corresponding to the plurality of circuit contacts; and
a cover in which a plurality of key holes are formed to expose keys located above the key contacts,
wherein the rubber-contact member comprises foldable parts for partitioning the rubber-contact member into two or more zones, making an interval between the zones to be easily adjusted while the foldable parts deform, and therefore allowing the zones to be in a one-to-one correspondence with relevant zones of the PCB.

7. The key input apparatus of claim 6, wherein the PCB and the rubber-contact member have a horizontal direction, the foldable parts are formed in a vertical direction, and the zones are arranged in the horizontal direction.

8. The key input apparatus of claim 6, wherein a thickness of each foldable part is less than a thickness of adjacent parts thereto.

9. The key input apparatus of claim 6, wherein each foldable part comprises at least one convex having a thickness less than a thickness of adjacent parts thereto.

10. The key input apparatus of claim 6, wherein the rubber-contact member comprises location limitation parts, at least one location limitation part being located in each zone.

11. The key input apparatus of claim 10, wherein the PCB comprises location limitation holes matching the location limitation parts of the rubber-contact member, and
the cover comprises location limitation members that extend from predetermined locations of a lower surface thereof and are inserted into the location limitation parts and the location limitation holes.

12. The key input apparatus of claim 6, further comprising at least one of keys, located above the key contacts formed in one body with the rubber-contact member, on the key contacts and buttons capped on the key contacts.

13. The rubber-contact member of claim 2, wherein the rubber-contact member has a first length in the horizontal direction and a second length in the vertical direction, wherein the first length is greater than the second length.

14. The key input apparatus of claim 7, wherein the PCB and rubber-contact member have a first length in the horizontal direction and a second length in the vertical direction, wherein the first length is greater than the second length.
